(19) United States
(12) Patent Application Publication
(10) Pub. No.: US 2024/0323648 A1
(43) Pub. Date: Sep. 26, 2024

(54) TOOL TRACKING SYSTEM AND MONITORING SYSTEM

(71) Applicant: Hubbell Incorporated, Shelton, CT (US)

(72) Inventors: Brian McCulloh White, Londonderry, NH (US); Michael Anthony Guarrera, Amherst, NH (US); Timothy Eugene Willis, Clemson, SC (US); Walter Lawrence Bretzer, Anderson, SC (US)

(21) Appl. No.: 18/612,748

(22) Filed: Mar. 21, 2024

Related U.S. Application Data
(60) Provisional application No. 63/454,110, filed on Mar. 23, 2023.

(51) Int. Cl. H04W 4/029; B25F 5/00

(52) U.S. Cl. CPC H04W 4/029; B25F 5/00

(57) ABSTRACT

A tool tracking system including a location module, configured to receive location information used to determine a tool's location and a communication module configured to communicate with at least one of a mobile computing device and a cloud-based computing system. Upon a triggering event, the communication module transmits at least one of the received location information and the tool's location to the at least one mobile computing device and the cloud-based computing system.

### CROSS-REFERENCE TO RELATED APPLICATIONS

This application is based on and claims priority to U.S. Provisional Application Ser. No. 63/454,110 filed Mar. 23, 2023 entitled Tool Tracking and Monitoring System the contents of which are incorporated herein in their entirety by reference.

### TECHNICAL FIELD

The present disclosure relates generally to a tracking and monitoring system, and more specifically to a tool tracking and monitoring system.

### DESCRIPTION OF THE RELATED ART

Handheld battery powered tools can often be very expensive, including handheld battery powered mechanical and hydraulic crimp and cutting tools that may cost customers several thousand dollars to purchase. These tools are valuable assets, but because they are small enough to be handheld, many customers are concerned about misplacing them, leaving them behind at a work site, or that such tools may be stolen. As a result, the market is seeking a cost-effective way to track tools and deter their theft.

One way to track tools is to document all the tools going to a particular work site and assign each tool to the site supervisor. At the end of the job, any tools that are not returned are logged as missing or stolen, and the site supervisor is responsible for lost, missing or stolen tools. This places an undue burden on the site supervisor, potentially distracting him/her from the job at hand as they focus their energy on making sure all tools are timely returned. Another way to track tools is to equip the tools with Bluetooth or other wireless communication components so that a smartphone running a mobile application, also known as an App, can log the location of the smartphone when the smartphone was last near the tool. Such methodology for tracking tools has several limitations, including a limited scope of coverage because only specific smartphones may track the location of the tool, and limitations on the use of phones at work sites in that many work sites do not allow any phones on the work site. A second limitation with this methodology for tracking the location of a tool is that the tool might not be close enough to communicate with anything using shortrange wireless communications (such as Bluetooth or WiFi). Another limitation with this methodology for tracking the location of a tool is that the App can only log the smartphone's location, the App does not know the actual location of the tool itself, which may be in a different location or a large distance away from the smartphone.

A more reliable and cost-effective approach to tracking portable tools is thus needed.

### SUMMARY OF THE INVENTION

The present disclosure provides exemplary embodiments of a tool tracking and monitoring system with a communication controller including a cellular modem. In an exemplary embodiment, the tool tracking and monitoring system includes a communication controller and a cloud-based computing system. Each communication controller has communication circuitry used for wireless communications. Each tool is configured to communicate with the communication circuitry of the communication controller to upload system information to a cloud-based computing system. The cloud-based computing system is in wireless communication with the communication controller directly and/or indirectly via a mobile computing device and is configured to receive system information from the communication controller and to store the system information in a database.

In an exemplary embodiment, the communication controller includes a communication circuit that includes a processor, a location module, a cellular modem, and a short-range communication module. In an exemplary embodiment, the communication controller may be located internally to the tool or may be configured to be removably mounted to the exterior of the tool. Beacon device includes a housing, a communication circuit and at least one indicator. The communication circuit is configured to receive system information from a tool and to upload the system information to a cloud-based computing system. The cloud-based computing system is in wireless communication with the communication controller directly and/or indirectly via a mobile computing device and is configured to receive system information from the communication controller and to store the system information in a database.

### BRIEF DESCRIPTION OF THE DRAWINGS

A more complete appreciation of the present disclosure and many of the attendant advantages thereof will be readily obtained as the same becomes better understood by reference to the following detailed description when considered in connection with the accompanying drawings, wherein:

FIG. 1 is a block diagram of a tool system according to an exemplary embodiment of the present disclosure;

FIG. 2 is a front perspective view of a tool according to an exemplary embodiment of the present disclosure;

FIG. 2A is a rear perspective view of a tool according to another illustrative embodiment of the present disclosure;

FIG. 2B is a rear perspective view of the tool depicted in FIG. 2A according to an illustrative embodiment of the present disclosure;

FIG. 3 is a schematic block diagram illustrating a tool system for the tool of FIG. 2 according to an exemplary embodiment of the present disclosure;

FIG. 4 is a schematic block diagram illustrating a tool control board of the tool system according to an exemplary embodiment of the present disclosure;

FIG. 5 is a schematic block diagram of a communication control board of the tool system according to an exemplary embodiment of the present disclosure;

FIG. 6 is a table illustrating a data structure for storing cycle information including tool location data during an operating cycle of the tool and time stamp data when the operating cycle of the tool occurred according to an exemplary embodiment of the present disclosure;

FIG. 7 is a system flow diagram showing a tool system associating a tool with a cloud computing system having a database according to an illustrative embodiment of the present disclosure;

FIG. 8 is an exemplary rendering of a home page of an App running on an external device forming part of a computing system used to manage the operation of one or more tools according to an exemplary embodiment of the present disclosure;

FIG. 9 is an exemplary rendering of a crimp history page of an App running on an external device forming part of a computing system used to manage the operation of one or more tools according to an exemplary embodiment of the present disclosure;

FIG. 10 is another exemplary rendering of a crimp history page of an App running on an external device forming part of a computing system used to manage the operation of one or more tools according to an exemplary embodiment of the present disclosure;

FIG. 11 is an exemplary rendering of a crimp comment page of an App running on an external device forming part of a computing system used to manage the operation of one or more tools according to an exemplary embodiment of the present disclosure;

FIG. 12 is an exemplary rendering of a service history page of an App running on an external device forming part of a computing system used to manage the operation of one or more tools according to an exemplary embodiment of the present disclosure;

FIG. 13 is a graphic illustration of a mobile computing device display according to an exemplary embodiment of the present disclosure;

FIG. 14 is a graphic illustration of a general-purpose computer display according to an exemplary embodiment of the present disclosure;

FIG. 15 is another graphic illustration of a general-purpose computer display according to an exemplary embodiment of the present disclosure;

FIG. 16 is another graphic illustration of a general-purpose computer display according to an exemplary embodiment of the present disclosure;

FIG. 17 is a process flow diagram of use of a tool associated with the tool system according to an illustrative embodiment of the present disclosure; and

FIG. 18 is a process flow diagram of an ongoing state of the tool system according to an illustrative embodiment of the present disclosure.

### DETAILED DESCRIPTION

The present disclosure provides descriptions of embodiments for tool tracking and monitoring systems mounted to or incorporated into a tool and is used for locating a tool and/or providing system information of the tool to a user. This disclosure and the accompanying drawings are to be regarded in an illustrative sense rather than a restrictive sense. Various modifications may be made thereto without departing from the spirit and scope of the present disclosure. For ease of description, the tool tracking and monitoring system 10 may also be referred to herein as the “tool systems” in the plural and the “tool system” in the singular.

The tools contemplated by the present disclosure may include any type of portable tool including, for example, power tools, mechanical tools and hydraulic tools. These portable tools may include corded as well as battery powered tools and may be handheld or temporarily setup in a fixed position. Non-limiting examples of such portable tools include portable table saws, chop saws, etc. Non-limiting examples of portable, handheld battery powered mechanical tools include drills, impact drivers, terminal crimpers, etc. Non-limiting examples of portable, handheld battery powered hydraulic tools include crimping tools and cutting tools which may be configured to apply force in a range of between about 6 tons and about 15 tons or more or less.

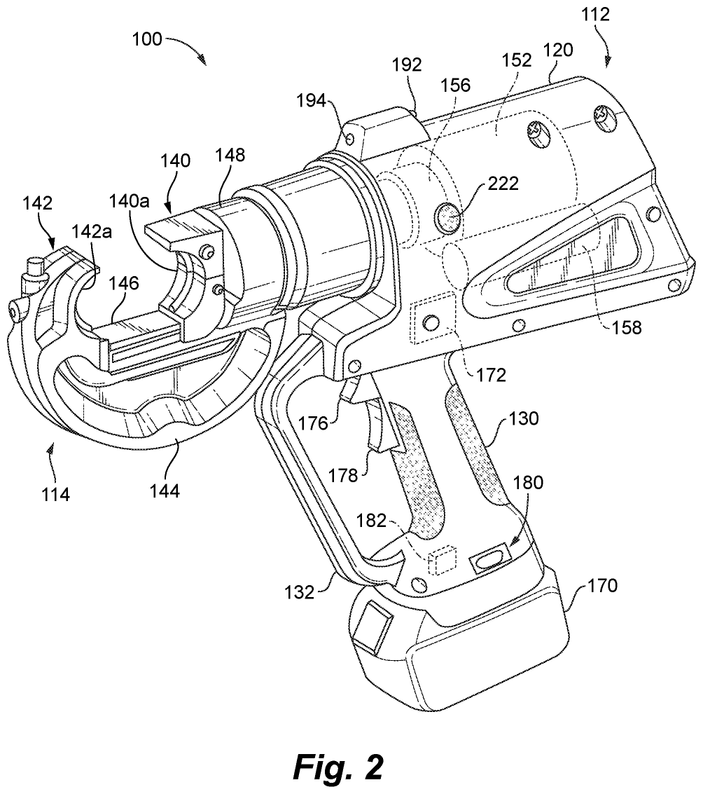

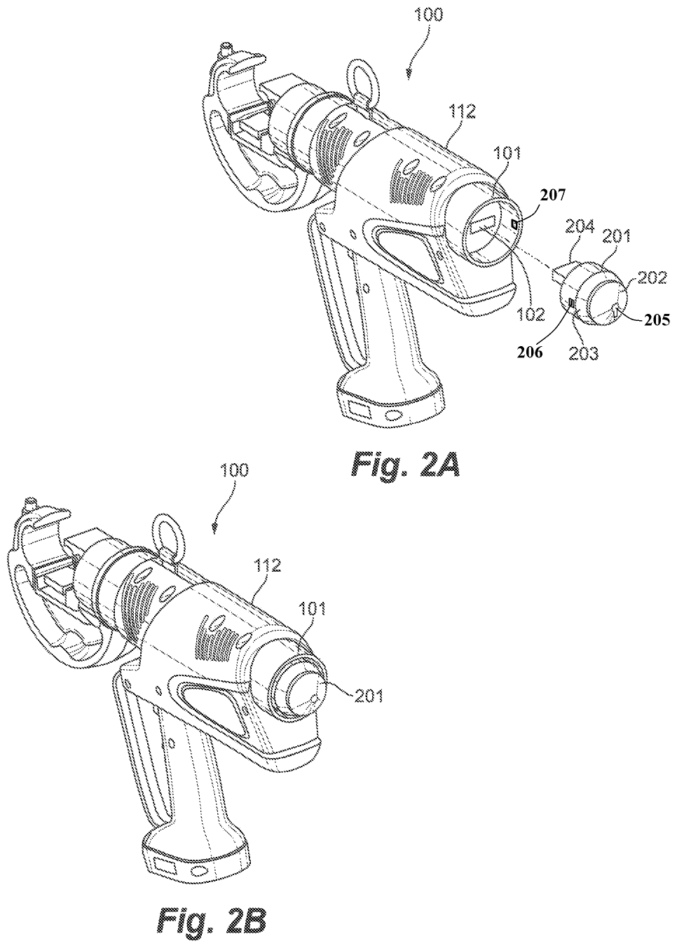

For ease of description, the tool described briefly herein is a portable, handheld, battery powered, hydraulic crimping tool as depicted in FIG. 2 and is used to form crimps and other electrical connections on workpieces and is referred to herein generally as tool 100. According to an illustrative embodiment of the present disclosure, tool 100 includes systems and circuitry for determining information including but not limited to information about and/or associated with the tool 100 and/or its operation, geographical location of the tool 100, and for monitoring and recording cycle information associated with crimp operating cycles of the tool 100. For ease of description, information about and/or associated with the tool 100 may be referred to herein simply as “tool information” or “system information”. The tool or system information may also include information about or associated with operation of the tool 100, including, for example, information relating to the operating cycles of the tool 100 which may be referred to simply as the “cycle information.” Thus, the system or tool information may include cycle information and/or any other information associated with the tool including, for example, monitoring system information which may include images associated with an operating cycle of the tool, etc. Cycle information may include detailed information about and/or associated with operating cycles of the tool 100. For example, according to an illustrative embodiment of the present disclosure, cycle information for a crimping tool may include, but is not limited to, the type and size of the workpiece to be crimped, a force applied by the tool 100 to form the crimp, a time stamp when the crimp was formed, a location of the tool 100 when the crimp was formed that establishes the location of the crimp, status of the crimp, and alpha-numeric information associated with the crimp. Each cycle data record may also include other system information, such as images associated with particular crimps. The time stamps contemplated by the present disclosure include, but are not limited to, the time of day a crimp was formed and the date a crimp was formed. According to an illustrative embodiment of the present disclosure, the system or tool information may include information about a geographical location of the tool 100.

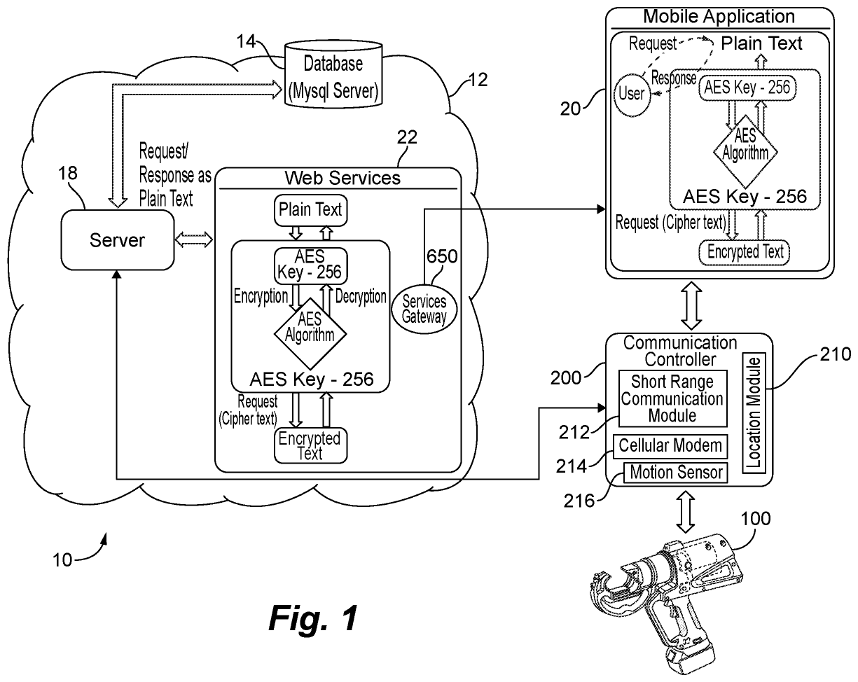

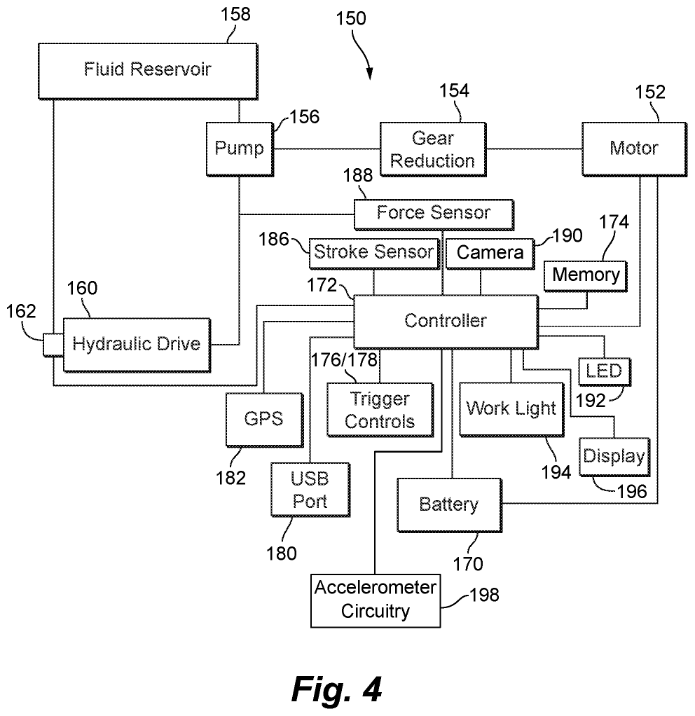

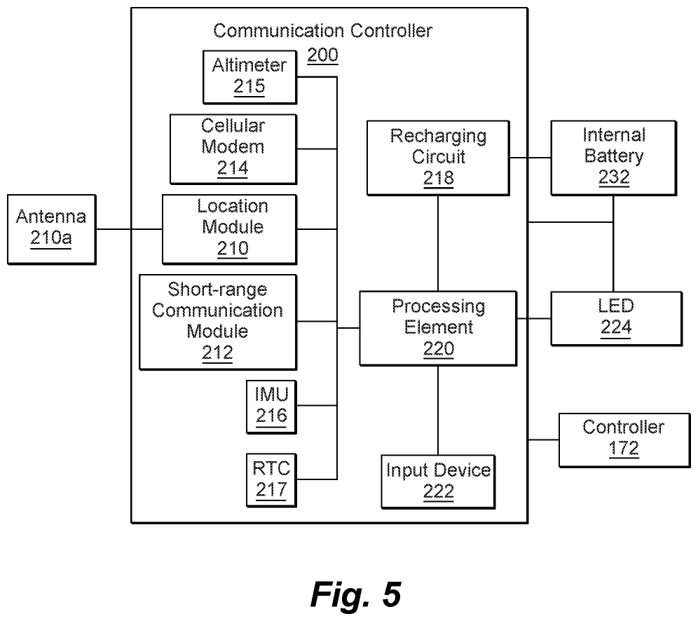

An overview of a tool tracking and monitoring system according to an illustrative embodiment of the present disclosure is shown in FIG. 1 and may be referred to herein simply as tool system 10. According to the present illustrative embodiment, tool 100 may include a communication controller 200 as depicted in FIGS. 1 and 5. Communication controller 200 may be provided within the body of tool 100, may be attached to an exterior of the body of tool 100 or may be otherwise associated with tool 100. For example, as shown in FIG. 2A, 2B, the communication controller 200 may be provided in a removable module 201. In particular, the components forming communication controller 200 me be provided on one or more circuit boards which may be encapsulated or otherwise enclosed in removable module 201. Module 201 includes a male connector 204 such as, for example, a male USB connector providing input/output to the communication controller 200 provided in the removable module 201. Tool frame 112 of tool 100 has a port 101 which includes a female connector 102 such as, for example, a female USB connector for receiving the male connector 204 provided in removable module 201. Communication controller 200 may provide its own power in the form of an internal battery provided in removable module 201. Alternatively, communication controller 200 may receive power from tool 100 via the connectors. Removable module 201 has a body 203 dimensioned to be press fit within port 101 provided in tool frame 112 and may include an outside lip 202 allowing a user to easily grasp module 201 for removal from port 101. According to an embodiment of the present disclosure a key/lock feature may be provided. For example, as shown in FIG. 2A, a keyway 205 may be provided in the distal end of removable module 201. Body 203 may include two or more orifices 206 (only one shown) through which latches extend when a key (not shown) is inserted in keyway 205 and rotated. When removable module 201 is inserted into port 101, the latches engage corresponding notches or holes 207 (only one shown) provided in port 101, locking the module 201 in place and requiring a key to be used to remove the module 201. According to another embodiment of the present disclosure, the firmware which controls tool 100 may be programmed so that the tool does not function of it senses the module 201 has been removed. For example, the processor 172 to be described later below with respect to FIG. 4, may send a signal to module 201 and if an acknowledgement is not received back from module 201, processor 172 will be put in a standby mode disabling the tool 100 from being used. According to an embodiment of the present disclosure, the system may be programmed so that the tool 100 will not function if module 201 has been removed, without unregistering the module 201.

Communication controller 200 may include short range communication module 212, cellular modem 214, inertial measurement unit (IMU) or motion sensor 216 and location module 210. As will be described in more detail later below by reference to FIG. 5, communication controller 200 may include other modules/circuitry performing additional functions and for providing additional information relating to tool 100. In the exemplary embodiment shown, the communication controller 200 is capable of uploading information relating to the tool 100 (e.g., tool or system information) directly or indirectly to a cloud-based computing system 12 as shown in FIG. 1 which may include one or more centralized databases 14 using one or more communication technologies, examples of which are described below. For example, direct communication between communication controller 200 and the cloud-based computing system 12 may include use of any suitable type of communication technology. Such communication technology includes, for example, any suitable type of cellular and mobile networks, such as GSM (Global System for Mobile Communication), GPRS (General Packet Radio Service), CDMA (Code Division Multiple Access), MOBITEX, EDGE (Enhanced Data for Global Evolution), etc. Direct communication between communication controller 200 and the cloud-based computing system 12 may in addition or alternatively, utilize low-power wide-area network technology, including, for example, Cat-M1 or NB-IoT. Indirect communication between the communication controller 200 and the cloud-based computing system 12 may utilize a mobile application, also known as an App, running on a mobile computing device 20, such as a smartphone, and a web service 22 running on a server 18. Web services 22 may include encryption/decryption software and/or hardware that convert plain text into encrypted text or encrypted text into plain text that is transmitted and/or received from mobile computing device 20 via gateway 650. Web services 22 may include encryption/decryption software or hardware that convert plain text in to encrypted text or encrypted text into plain text that is transmitted and/or received from mobile application 20 via gateway 650. Mobile computing device 20 may include encryption/decryption software or hardware that convert plain text into encrypted text or encrypted text into plain text that is transmitted and/or received by web services 22 via gateway 650.

Referring to FIG. 1, according to an illustrative embodiment of the present disclosure, the cellular modem 214 may update the cloud computing system 12 database 14 directly with system information from the tool 100. It is noted that the tool 100 may also be configured to communicate to a mobile computing device 20 or to any other device or system as used in the conventional sense where there is a one-time association between the devices and the details of the association are saved for later connections so that when the devices are within a predefined communication distance using, for example, Bluetooth, BLE, Wi-Fi, cellular or other communication technologies, the devices connect so that the devices can communicate. It is noted that the predefined communication distance is a distance at which one device, e.g., tool 100, receives wireless signals from another device, e.g., mobile computing device 20, with sufficient signal strength in which to wirelessly communicate with each other.

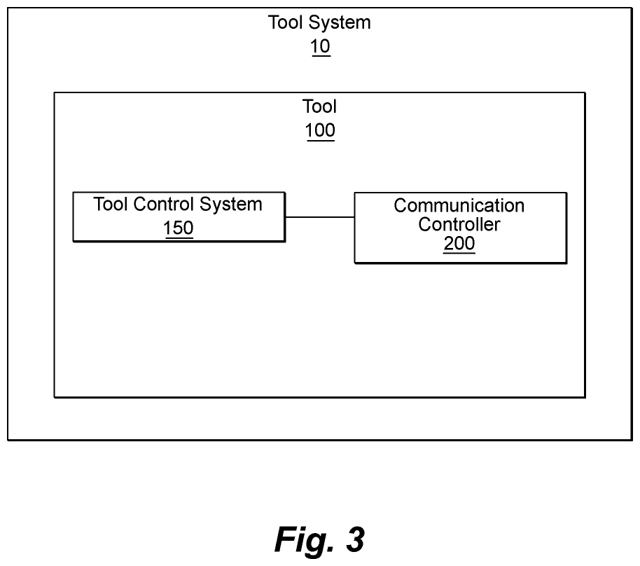

FIG. 2 shows a hydraulic power tool 100 according to an illustrative embodiment of the present disclosure. The tool 100 includes a tool frame 112 and a working head 114. The tool frame 112 includes a main body 120 and a handle 130 that form a pistol-like shape. However, the tool frame 112 could be any suitable type of shape. Within the main body 120 of the tool frame 112 is a battery driven tool control system 150 as shown in FIG. 4 and communication controller 200, as shown in FIG. 1, but which are illustrated schematically in FIG. 3 and may be referred to herein as tool control system 150 and communication controller 200, respectively. It will be appreciated the tool control system 150 and/or the communication controller 200 may be incorporated within the tool 100, provided exterior to the tool 100 or otherwise associated with the tool 100 in various ways.

As shown in FIG. 4, according to an illustrative embodiment of the present disclosure, the tool control system 150 may include a battery 170, a controller 172, a GPS 182, a USB port 180, a memory 174, a display 196, a camera 190, one or more operator controls 176 and 178, a force sensor 188, a accelerometer circuitry 198 one or more status indicators 192, e.g., one or more LEDs, and/or audio/haptic feedback. The tool control system 150 is configured to control the drive system of tool 100. In an exemplary embodiment, the drive system is a hydraulic drive system that includes a motor 152, a gear reduction box 154, a pump 156, a hydraulic fluid reservoir 158, a hydraulic drive 160 and an optional relief valve 162. Alternatively, however, the drive system may be an electro-mechanical system utilizing essentially just a motor 152 and gear reduction box 154.

FIG. 3 shows a schematic block diagram of an exemplary embodiment of a tool system 10 including a tool 100 having a tool control system 150 in communication with a communication controller 200. The tool control system 150 collects system information relating to operation of the tool 100 and sends the system information to the communication controller 200. Some non-limiting examples of system information that may be collected by the tool control system 150 of the exemplary tool 100 which may be a crimping tool and may include, but is not limited to, the type and size of the workpiece to be crimped, a force applied by the tool 100 to form the crimp, status of the crimp, alpha-numeric information associated with the crimp, and images associated with particular crimps. It is contemplated that the system information provided by the tool control system 150 as seen in FIG. 4 may vary depending on the type of tool 100. For example, a tool control system 150 associated with a cutting tool may provide system information including, but not limited to, the type and size of the workpiece to be cut, an angle of the cut performed on the workpiece by the tool 100, alpha-numeric information associated with the cut, and images associated with particular cuts. The system information may be stored in memory 174 associated with controller 172 and/or in memory associated with processor 220 as seen in FIG. 5 or any other suitable memory accessible or otherwise available to processor 220. The communication controller 200 may supplement the system information provided by the tool control system 150 with additional system information collected by the communication controller 200 as seen in FIG. 1 and upload the system information for access by a user, as will be described in more detail below.

Some non-limiting examples of system information that may be collected by the communication controller 200 in this exemplary embodiment may include, but is not limited to, a location of the tool 100 and time when the crimp was formed that establishes the location of the crimp and the time stamp indicating when the crimp was formed. It is contemplated that the system information provided by the communication controller 200 may vary depending on the type of tool 100 the tool system 10 is associated with. For example, a communication controller 200 of a tool system 10 associated with a cutting tool may provide system information including, but not limited to, a location of the tool 100 and time when the cut was made that establishes the location of the cut and a time stamp when the cut was formed.

FIG. 4 shows a schematic block diagram of electrical and electromechanical components associated with the tool control system 150. According to an illustrative embodiment, controller 172 may be a programable processor such as a microcontroller that includes software for performing the functions of operating the tool 10 on a workpiece, e.g., crimping wire, making a cut, etc., and/or for performing the functions of providing feedback regarding the work done on the workpiece, i.e., system information. The controller 172 may be a microprocessor, microcontroller, application specific integrated circuit, field programable gate array (FPGA) or other digital processing apparatus as will be appreciated by those skilled in the relevant art. The controller 172 communicates with memory 174 to receive program instructions and to retrieve and/or store data. Memory 174 may be read-only memory (ROM), random access memory (RAM), flash memory, and/or other types of electronic storage known to those of skill in the art. The memory 174 may be integrated into controller 172, or in one or more ICs or modules. The controller 172 may be configured to communicate with communication controller 200 (e.g., see FIG. 3) wirelessly and/or by a wired connection. Controller 172 is connected with a power supply such as a battery 170.

The battery 170 provides power to the controller 172. The battery 170 also provides power to the motor 152 under the control of the controller 172 and the operator controls 176 and 178. The motor 152 drives the pump 156 via gear reduction box 154. The pump 156 is in fluid communication with the hydraulic fluid reservoir 158. When driven by the motor 152, the pump 156 delivers fluid under pressure from reservoir 158 to the hydraulic drive 160. Force generated by hydraulic drive 160 is delivered via a drive arm (not shown), such as a piston within the frame 112 as seen in FIG. 2, to the working head 114. The force sensor 188 is provided to measure the force applied to a workpiece. Information relating to the force measured may be stored by controller 172 in memory 174 and/or in memory associated with processor 220. Non-limiting examples of the force sensor 188 include pressure sensors or transducers, load cells, strain gauges and other force measuring devices. In the exemplary embodiment of the tool 100 described herein, the force sensor 188 is a pressure transducer. The pressure transducer 188 is connected to the hydraulic drive 160 and senses the hydraulic pressure in the hydraulic drive 160. The controller 172 receives data indicating the pressure in the hydraulic drive 160 from the pressure sensor 188 and determines (or computes) a force applied by the tool 100 on the workpiece. The controller 172 receives signals from the one or more operator trigger controls 176, 178 to activate and deactivate the motor 152 which activates and deactivates the hydraulic drive 160. When the controller 172 activates the motor 152, a work light 194 positioned on the main body 120 of the tool frame 112 may also be activated to illuminate an area of the working head 114 during an operating cycle of the tool 100, here during a crimp cycle. In addition, when the controller 172 activates the motor 152, processing element 220 as shown in FIG. 5 may retrieve and store time stamp information from RTC 217 indicating the time the motor 152 was activated and when the crimp was performed.

The relief valve 162 connects the hydraulic drive 160 with the fluid reservoir 158. According to an embodiment, the relief valve 162 is a mechanically actuated valve designed to open when a predetermined maximum pressure is reached in the tool control system 150. When the relief valve 162 is opened, fluid flows from the hydraulic drive 160 back to reservoir 158 relieving pressure in hydraulic drive 160 and removing the force applied on the workpiece by the drive arm (not shown). A spring (not shown) may be provided as part of hydraulic drive 160 to return the drive arm, e.g., a piston within the frame 112, to a home position, shown in FIG. 2, when pressure in hydraulic drive 160 is relieved. It is noted that when the relief valve 162 opens, the relief valve 162 may make an audible indication, such as a “pop” like sound, that the relief valve 162 has opened.

The controller 172 may monitor the pressure in hydraulic drive 160 to determine when a crimp cycle is complete. For example, after actuating the motor 152 in response to activation of an operator control, e.g., trigger switch 178, the controller 172 monitors the hydraulic fluid pressure in the hydraulic drive system 160 via the force sensor 188. To measure the force applied by the impactor 140 on the workpiece, the force sensor 188, which in this exemplary embodiment is a pressure transducer, which is located in fluid communication with the hydraulic drive 160. When the drive arm drives the impactor 140 distally until the impactor 140 is in the crimping position, the force applied by the impactor 140 onto the workpiece is monitored by the force sensor 188. Information relating to the force applied during an operating cycle may be stored by controller 172 and/or processor 220 as shown in FIG. 5 as system information which can later be uploaded for access by the user. According to yet another embodiment of the disclosure, the force sensor 188 may be located elsewhere, such as between the impactor 140 and the anvil 142, or between the impactor 140 and a die attached to the impactor 140 or between the anvil 142 and a die attached to the anvil 142 to measure force applied by impactor 140 on the workpiece. According to another embodiment, the force sensor 188 may be a strain gauge mounted on arm 144 and used to measure the force applied to a workpiece.

In embodiments where the optional relief valve 162 is included, when the relief valve 162 opens and the pressure in the hydraulic drive system drops below a predetermined minimum threshold, the controller 172 determines that a crimp cycle is complete. In embodiments where the relief valve 162 is not included, the controller 172 monitors the pressure via the force sensor 188 and when the pressure in the hydraulic drive system reaches a predetermined threshold, e.g., about 5,000 psi or about 11,000 psi, the controller 172 determines that sufficient pressure has been applied to the workpiece such that the operating cycle (e.g., the crimp cycle), is complete. In addition or alternatively to storing time stamp information indicating the time the motor 152 was activated indicating an operating cycle has begun as described above, processing element 220 may retrieve and store time stamp information indicating when controller 172 determines the operating cycle is complete.

As shown in FIG. 2, an indicator light 192 is positioned on a top portion of the main body 120 of the tool frame 112 facing in the proximal direction so that it is visible to the tool user. The indicator light 192 is electrically connected to the controller 172. According to one embodiment, the light 192 is a bi-color LED that can be energized to illuminate in two distinct colors, such as red and green. However, other types of LED indicators may be used, such as a tri-colored LED capable of emitting red, green and yellow light. When the controller 172 determines that the crimp cycle is complete and that the hydraulic drive system has reached a predetermined threshold pressure, the controller 172 energizes light 192 to illuminate green to indicate a successful crimp. Information regarding the pressure the hydraulic drive system reached during the crimp cycle may also be saved by controller 172 in memory 174 and/or processor 220. If the hydraulic drive system was not able to reach the predetermined threshold pressure during the crimp cycle, because, for example, there was insufficient battery power to reach the desired threshold pressure or because the pressure setting of the relief valve 162 is out of calibration, the controller 172 energizes the light 192 to illuminate red. Controller 172 and/or processor 220 may also save system information relating to the failed crimp cycle. This system information may simply include an indication the system did not reach the desired threshold pressure. In addition or alternatively, this system information may include the value of the pressure that was reached as well as the value of the desired threshold pressure. The information may include an indication of the battery voltage level at the time of the failed crimp cycle. It is noted that the present disclosure also contemplates that the controller 172 may activate a sound generating device (not shown) when the controller 172 determines that the crimp cycle is complete, and that the hydraulic drive system has reached a predetermined threshold pressure to indicate a successful crimp.

Continuing to refer to FIGS. 2 and 4, the battery 170 may be removably connected to the bottom of the handle 130. In another embodiment, the battery 170 could be removably mounted or connected to any suitable position on the tool frame 112. In another embodiment, the battery 170 may be affixed to the tool 100 so that it is not removable. The battery 170 is preferably a rechargeable battery, such as a lithium-ion battery, that can output a sufficient voltage for the tool 100 to perform multiple operating cycles. For example, the battery 170 may be a rechargeable battery of at least 16 VDC. Information regarding the status of the battery 170 at the time of operation of the tool 100 (e.g., during and/or after a crimping operation) may also be stored as system information that can later be uploaded and presented to the user. This information may indicate simply that battery 100 is low, and the actual remaining power level available, etc.

The handle 130 also supports the one or more operator controls, such as the trigger switches 176 and 178, that can be manually activated by a tool user. The handle 130 may include a hand guard 132 to protect a tool user's hand while operating the tool 100 and to prevent unintended operation of trigger switches 176 and 178. According to an embodiment of the present disclosure, one of the operator controls (e.g., trigger switch 178) may be used to activate the hydraulic and control system 150 while the other operator control (e.g., trigger switch 176) may be used to cause the hydraulic and control system 150 to deactivate so that the hydraulic drive 160 is depressurized.

The working head 114 of the tool 100 may include an impactor 140, and anvil 142, an arm 144 and a guide 146. The impactor 140 has a working surface 140a and is configured to move between a home position, shown in FIG. 2, and a crimping position in which the impactor 140 is acting on the workpiece (not shown). The impactor 140 is configured and dimensioned to connect to or couple with the drive arm (not shown) of the hydraulic and control system 150 within the main body 120 of the tool frame 112. The drive arm may be, for example, a piston for driving impactor 140. As described above, in an exemplary embodiment, one of the trigger switches (e.g., trigger switch 178) may be used to activate the hydraulic and control system 150 by activating the motor 152 that causes the hydraulic pump 156 to activate via the gear reduction box 154 which pressurizes the hydraulic drive 160 to drive the impactor 140 in a direction toward the anvil 142. Driving the impactor 140 in the direction of the anvil 142 causes the impactor 140 to move to the crimping position and deliver force to the workpiece, e.g., a lug connector or a splice connector, onto a conductor. The other trigger switch (e.g., trigger switch 176) may be used to cause the hydraulic and control system 150 to deactivate so that the hydraulic drive 160 is depressurized causing the drive arm 144 to retract in the proximal direction to the home position, shown in FIG. 2. As noted above, a spring (not shown) may be provided as part of hydraulic drive 160 to return the drive arm, e.g., the piston and impactor 140, to the home position when pressure in hydraulic drive 160 is relieved. The impactor 140 is operatively coupled to the guide 146 on the arm 144 of the working head 114 so that the impactor 140 can move along the guide 146 as the drive arm moves the impactor 140 between the home and crimping positions. For example, when the drive arm is driven in the direction of the anvil 142, the drive arm moves the impactor 140 along the guide 146 from the home position, seen in FIG. 2, toward the crimping position.

The arm 144 has at its proximal end a ring 148 used to connect the working head 114 to the tool frame 112, as is known. In one exemplary embodiment, the working head 114 and the frame 112 may be permanently joined with one another via the ring 148. The ring 148 has a center aperture (not shown) through which the drive arm passes in order to connect to the impactor 140. The distal end of the arm 144 includes or forms the anvil 142 such that the anvil 142 is fixed in position. The anvil 142 has a working surface 142a. When a workpiece, such as a lug connector or a splice connector, is placed in the working head 114 between the impactor 140 and the anvil 142, and a conductor or conductors are inserted into workpiece, the motor 152 of the tool 100 can be activated so that the impactor 140 is driven from the home position toward the crimping position. As the impactor 140 moves toward the anvil 142, the workpiece may also move toward the anvil 142. When the impactor 140 and anvil 142 both contact the workpiece further movement of the impactor 140 causes the working surface 140a of the impactor 140 and the working surface 142a of the anvil 142 to deform the workpiece thus making the crimp. It is noted that the home position is when the impactor 140 is adjacent the ring 148 and the crimping position is when the impactor 140 and anvil 142 deform the workpiece.

According to another embodiment, the working head 114 and/or the anvil 142 and impactor 140 may be removable and capable of being replaced with a variety of working heads 114 and/or anvils 142 and impactor 140. Each of the variety of working heads 114 and/or anvils 142 and impactor 140 may be configured to cut or provide a crimp on different sized wires or cables and/or to provide differently configured crimps. In this case, the working heads 114 and/or anvils 142 and impactor 140 may include information provided thereon uniquely identifying the working head and/or anvil 142 and impactor 140. Camera 190 (FIG. 4) may be used to capture this information on the working head 114 and/or anvil 142 and impactor 140. Controller 172 and/or processor 220 may then store the information as system information which can later be uploaded for access by the user.

According to yet another illustrative embodiment, a stroke sensor 186, as shown in FIG. 4, may be provided. The stroke sensor 186 monitors the drive arm and determines when the drive arm and thus the impactor 140 has reached the end of its range and/or that the working surfaces of the impactor 140 and anvil 142 or die attached to the impactor 140 and anvil 142 are at their closest approach. When the working surfaces are at their closest approach, the space defined by the working surfaces form the desired shape of the finished crimp connection. The controller 172 monitors the stroke sensor 186 and when the drive arm and thus the impactor 140 is at the end of its range, the controller 172 may, if the optional relief valve 162 is included, open the relief valve completing the operation cycle of the tool 100. In embodiments where the relief valve 162 is not included, the controller 172 monitors the stroke sensor 186 and when the drive arm and thus the impactor 140 is at the end of its range, the controller 172 turns the motor 152 off completing the operation cycle of the tool 100. The controller 172 may also monitor the force sensor 188, and as with the previous embodiments, the light 192 can be illuminated either green or red, depending on whether a threshold pressure was reached during the operating cycle. In other embodiments, the controller 172 may also monitor the stroke sensor 186 and/or the force sensor 188 to record and store system information for tool cycle quality assurance purposes that may be later uploaded as system information for access by a user.

According to a further embodiment, the force sensor 188 may be a load cell that monitors the force applied to the workpiece during the crimp cycle. The force measurement by the force sensor 188, e.g., a load cell, may be used by the controller 172 instead of (or in addition to) the pressure monitored by a force sensor 188, e.g., a pressure sensor, to determine whether sufficient maximum force is applied during an operating cycle of the tool 100. The force sensor 188 may be a load cell that is positioned between the impactor 140 and the anvil 142, or between the impactor 140 and one of the die (not shown) attached to the impactor 140 or between the anvil 142 and one of the die (not shown) attached to the anvil 142.

According to another embodiment, the tool 100 may also include a camera 190 mounted to the tool frame 112 and oriented to provide a video and/or still pictures of the workpiece the working head 114 may operate during a crimping or cutting cycle and/or the information identifying the replaceable working head 114 and/or anvil 142 and impactor 140 as described above. Camera 190 may replace work light 194 or be provided adjacent to work light 194 providing a clear view of working head 114. The video and/or still pictures from camera 190 may form part of the cycle data record forming a part of the system information to be uploaded for access by the user.

Communication controller 200 according to an illustrative embodiment of the present disclosure is shown in more detail in FIG. 5. The communication controller 200 is configured to communicate system information to cloud-based computing system 12 (e.g., see FIG. 1) either directly or indirectly. The communication controller 200 may be incorporated into the tool 100 or may be a standalone device that is capable of being removably attached to the tool 100 by clips, fasteners, or the like. It is envisioned that in a standalone embodiment, the communication controller 200 may include its own housing, communication circuitry, and at least one indicator. The communication controller 200 may include a cellular modem 214, a location module 210, an input device 222, a short-range communication module 212, an IMU or motion sensor 216, a recharging circuit 218, an internal battery 232, and a processing element 220. According to an illustrative embodiment, the cellular modem 214 may have an internal processor that would obviate the need for processor 220. Although not shown, the communication controller 200 may include a subscriber identity module (SIM) card and/or the cellular modem 214 may be associated with a SIM card. By deploying embodiments of the communication controller 200 contemplated by the present disclosure in or on the tool 100 itself, the location of the tool 100 as well as information relating to operation of the tool 100 can be automatically and accurately recorded and uploaded for user access. Utilizing the cellular modem 214, the user can have access to this information without the need to use a smartphone with a particular mobile application (App) running on the smartphone in the vicinity of the tool 100. More specifically, the communication controller 200 having a cellular modem 214 and a location module 210, e.g., an onboard GPS device, described below, location information relating to the location of the tool 100 can be included in the system information when the tool 100 uploads the system information for access by the user. The location information may include just the raw satellite data itself and/or may include latitude/longitude information and/or may include an actual town, street, address information to be displayed to the end user via mobile computing device 20 and/or general-purpose computer 24. Information including just the raw satellite data itself and/or latitude/longitude information may be processed after receipt by cloud-based computing system 12 to be displayed to the end user. As a result, the location of the tool 100 will be readily accessible by the end user.

Internal circuitry of the communication controller 200 may be mounted on one or more printed circuit boards that may be mounted within a cavity of the tool 100 or externally on the tool 100. One skilled in the art will appreciate there are numerous options for placement of the communication controller 200 on or in the tool 100. According to an illustrative embodiment, cellular modem 214 may include an internal memory and may store and/or have access to Tower Atlas information providing location information relating to cell towers and wireless antennas. An internal battery 232 may be provided which is electrically coupled to, and supplies power to, all the electronic components of the communication controller 200. The battery 232 is preferably a rechargeable battery, such as a lithium-ion battery, that can output a sufficient voltage for the communication controller 200 to process information and to communicate information to, for example, a cell tower and/or communicate with the mobile computing device 20. A recharging circuit 218 is also associated with the internal battery 232. The recharging circuit 218 may charge the internal battery 232 from the battery 170. According to another embodiment, battery 232 may be omitted and battery 170 (FIG. 4) may provide power to the communication controller 200 and the tool control system 150.

According to an illustrative embodiment, the communication controller 200 as shown in FIG. 5 includes a processing element 220 (also referred to as processor(s), processing circuitry, and/or similar terms used herein interchangeably) that communicates with other elements within the communication controller 200 via a data bus, for example. As will be understood, the processing element 220 may be embodied in a number of different ways known in the art. For example, the processing element 220 may be embodied as one or more complex programmable logic devices (CPLDs), microprocessors, multi-core processors, coprocessing entities, application-specific instruction-set processors (ASIPs), microcontrollers, and/or controllers. Further, the processing element 220 may be embodied as a combination of one or more of these processing devices or circuitry. The terms devices and circuitry may refer to an entirely hardware embodiment or a combination of hardware and computer program products. Thus, the processing element 220 may be embodied as integrated circuits, application specific integrated circuits (ASICs), field programmable gate arrays (FPGAs), programmable logic arrays (PLAs), hardware accelerators, other circuitry, and/or the like.

According to an illustrative embodiment of the present disclosure, location module 210 is operable to determine a location of the tool 100 based on signals received from a global navigation system. Non-limiting examples of global navigation systems include the global navigation satellite system (GNSS), the Global Positioning System (GPS), or the Next Generation Operational Control System (OCX) operated by the United States government, the Global Navigation Satellite System (GLONASS) operated by the Russian government, the BeiDou Navigation Satellite System (BNS) operated by the Chinese government, the Quasi-Zenith Satellite System (QZSS) operated by the Japanese government, the Galileo Positioning System operated by the European Union, the India Regional Navigation Satellite System (NAVIC) or the like. As an example, if the global navigation system is the GNSS, the location module 210 would be a GNSS antenna module, such as the SAM-M8Q module manufactured by Ublox. The location module 210 having an integral antenna or an antenna operatively connected with the location module 210 may be located near the surface of the handle 130 of the tool frame 112, as shown in FIG. 2, to ensure that it can receive signals from GNSS satellites. In another exemplary embodiment, the location module 210 or antenna may be located near the surface of the main body 120 of the tool frame 112. However, it will be appreciated that the location of the location module 210 or antenna on the tool 100 may be anywhere that allows the location module 210 or antenna to receive signals from the satellites used to determine the location of the tool 100. In an embodiment, the location module 210 may be associated with an antenna 210a to improve the location module's 210 receiving of signals from the satellites. In another aspect, the cellular modem 214 may also be used to help in determining an even more accurate location of the tool 100. Non limiting examples of such use include assisted GPS taking advantage of cell tower data, a Wireless Local Area Network IEEE 802.11 (WiFi) position system, cell-site multilateration, and satellite multilateration. Multilateratiom is a technique that estimates the location of a wireless emitter and the target position is determined by the time difference between the signals. A hybrid positioning system may also be used in order to improve location accuracy and provide a faster Time-To-First-Fix (TTFF), for example, when GPS signals are poor or unavailable. Hybrid positioning systems find locations using several different technologies, such as the ones mentioned above, specifically, technologies such as GPS combined with cell tower signals. The cellular modem's role in locating the tool 100 is discussed below.

The cellular modem 214 may improve the startup performance, i.e., time-to-first-fix (TTFF), of the location module 210. The cellular modem 214 may be configured to connect to an assisted GPS (A-GPS) server to download the satellite orbital information. The cellular modem uses A-GPS to obtain the GPS navigation messages to assist the location module 210 to calculate its positioning faster or when GPS signals are poor or unavailable. The cellular modem 214 can communicate with cell towers via one or more of the communication technologies described above including, for example, any suitable type of cellular and mobile networks, such as GSM (Global System for Mobile Communication), GPRS (General Packet Radio Service), CDMA (Code Division Multiple Access), MOBITEX, EDGE (Enhanced Data for Global Evolution), etc., and/or a low power wide area network (LPWAN) radio technology standard which allows long-range communication at a low data rate, reducing the power and cost of transmission. In an embodiment, the LPWAN standard uses NB-IoT protocols. In another embodiment, the LPWAN standard uses Cat-M1 protocols. In an embodiment, the cellular modem 214 may be associated with an antenna to improve the cellular modem's 214 transmitting and receiving of signals to and/or from the cell tower capability.

Communication controller 200 may also include an Inertial Measurement Unit or IMU sensor 216 electrically coupled with the processing element 220. One of ordinary skill in the art will appreciate that many types of IMUs may be used. Non-limiting examples of IMUs include accelerometers, gyroscopes, and magnetometers. The IMU sensor 216 may be used to determine whether the tool 100 is moving, i.e., being moved, or stationary. The use of the IMU sensor 216 in the tool 100 is described in greater detail below.

The communication controller 200 may also include a real-time clock (RTC) 217 that may be used to record various points in time including various points in time relating to work cycles of tool 100 including, for example, a point in time the tool 100 completes a work cycle, e.g., crimp.

The communication controller 200 may also include an altimeter 215 to provide altimetry information which may be used by processing element 220 to identify a floor of the building the tool 100 may be located or had been used. This information may be stored as additional system information that can be uploaded for later access by the user and used to further isolate the precise location of tool 100.

Input device 222 communicates to the controller 172 and can be used to initiate or perform a number of different operations. The input device 222 may be, for example, a pushbutton switch. Non-limiting examples of the operations that may be initiated or performed by the input device 222 include pairing the tool 100 to a mobile user device 20 (FIG. 1). The input device 222 may be provided on the main body 120 or the handle 130 of the tool frame 112 so that a tool 100 user can easily activate the input device 222.

In some embodiments, the communication controller 200 may include one or more indicators 224 that provide the tool user with visual, audio, haptic feedback, or some combination thereof that the tool 100 has successfully connected to network and/or has successfully transmitted tool information. For example, according to an embodiment of the present disclosure, indicators 224 may include an LED to alert the user of network connection and the transmitting status of the tool information by the communication controller 200.

According to an embodiment of the present disclosure, the communication controller 200 can be programmed such that processor 220 will receive location information at regular intervals from the location module 210 and/or the cellular modem 214. That information may be stored, for example, in memory associated with processing element 220. That information may then be uploaded to cloud computing system 12 (FIG. 1) either as raw data to be later processed to determine an actual location or processed and uploaded as processed data indicating an actual location. According to another embodiment of the present disclosure, the IMU 216 may be used to determine when the tool 100 is being moved. To save power, instead of receiving the location information at regular intervals, the location information may be provided to processor 220 only when movement is detected by the IMU 216. For example, the location module 210 may be activated and the location information may be provided to processor 220 for storage when IMU 216 first detects motion or after a predetermined time interval (e.g., 5 minutes) has passed without additional movement being detected.

According to embodiments of the present disclosure, communication controller 200 may be configured to store other system information, such as cycle information, e.g., tool crimp histories, etc. As the tool 100 is paired with a mobile computing device 20, e.g., a smartphone, the short-range communication module 212 may upload the latest system information to the mobile computing device 20 which may then upload the latest system information to the cloud computing system 12 and database 14 (FIG. 1). In this embodiment, the communication protocol is based on a wireless local area network (WLAN) technology, e.g., BLE. In another embodiment, the communication controller 200 of the tool 100 may be configured to wirelessly access the internet by communicating with cell towers via a low power wide area network (LWAN) radio technology standard; such as NB-IoT protocols or Cat-M1 protocols.

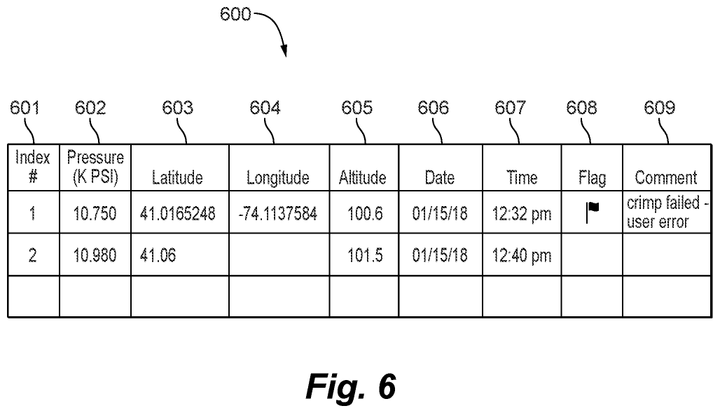

Referring to FIG. 6, an example of crimp data records of crimp information stored in memory 174 is shown in a table of cycle data records 600. As described herein, the cycle data records 600 may be part of the system information. The cycle data records are illustrated here by a table of data arranged in rows. Of course, a variety of data structures known to those with skill in the relevant field could be used. In this embodiment, each row records cycle information for a particular operating cycle, here a crimp cycle, of the tool 100. In the column 601 of the table 600 an index number is stored. According to an illustrative embodiment, the index number is indicative of the particular crimp cycle performed by the tool 100 out of the total number of cycles the tool 100 has made and serves to uniquely identify each crimp cycle recorded. The index number may also be used to determine if the tool 100 needs to be recalibrated according to a maintenance schedule. Column 602 records the maximum force, e.g., pressure, applied or a maximum hydraulic pressure achieved by the hydraulic drive 160 during the crimp cycle. Alternatively, instead of recording a maximum force or pressure, a logical value (e.g., “Pass” or “Fail”) indicating that sufficient pressure was or was not achieved during the crimp cycle could be recorded. Columns 603 and 604 record the location of the tool 100 when the crimp is formed, e.g., at the completion of a crimp cycle. According to a further embodiment, the altitude of the tool 100 may be recorded in column 605 so that if the tool 100 is used on a floor of a building, the floor of the building where the crimp was made can be determined based on the altitude information. According to a further embodiment, in addition or alternatively to providing the latitude and longitude of the location of the tool 100, the actual address indicating the location of tool 100 may be determined by controller 172 and/or processor 220 and stored as part of the table 600. Columns 606 and 607 record the date and time stamp, respectively, associated with when the crimp cycle was completed and/or activated. In the exemplary embodiment of FIG. 6, the time stamp includes the time and date when the crimp cycle was activated. In another embodiment, the time stamp may be represented by a single value, e.g., in Unix Time. Column 608 holds a flag that may have been added to the data record by activating the input device 222, seen in FIG. 5, following a crimp cycle. For example, according to the illustrative embodiment illustrated in FIG. 6, the first cycle data record includes a flag indicating the data record in Column 609 has been added. Column 609 holds alpha-numeric comments that may have been added to the data record by the tool user, such as “crimped failed due to user error.” The present application also contemplates that the comments may include crimp location information or other information that may confirm or help with the location of crimps formed by a particular tool 100. In another embodiment, other information related to the crimp operation (cycle information) could be stored, such as stroke measurement or resistance verification. For each subsequent cycle of the tool 100, a new cycle data record of cycle information is added to memory 218, as illustrated by a new row of the table.

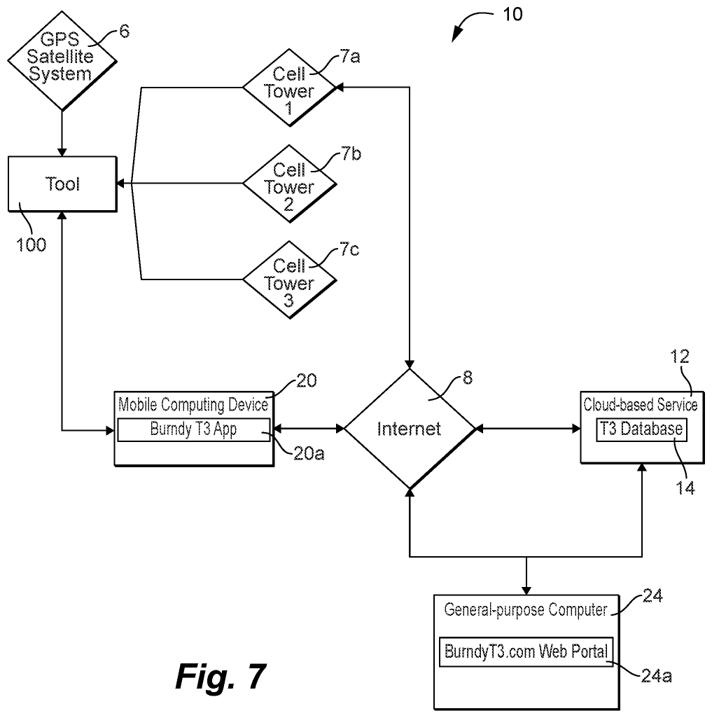

Referring to FIG. 7 in conjunction with FIG. 1 is a system diagram showing a tool system 10 associating a tool 100 with a cloud computing system 12 having a database 14 from which a user may be able to access system information of the tool 100 according to embodiments of the disclosure. The tool 100 receives signals from a GPS satellite system 6. In addition, Tool 100 may also acquire current satellite positions over the Internet 8 to improve Time-To-First-Fix, thus, reducing time to determine a valid location and improving accuracy. Tool 100 may also access signals from one or more of cell towers 7a-7c and use Trilateration or Multilateration to improve location determination based on the signal delay to the one or more (and preferably multiple) nearby cell towers. The tool 100 may then upload system information to the database 14 either directly or indirectly. According to an embodiment, to upload the system information indirectly, the tool 100 may utilize a communication protocol based on a WLAN technology, e.g., BLE, to communicate between the tool 100 and a mobile user device 20, e.g., smartphone running an App 20a. The mobile user device 20 may utilize App 20a to then upload the system information via the Internet 8 to the cloud computing system 12 for storage by database 14. According to an embodiment of the present disclosure, to upload the system information directly to database 14, the tool 100 may wirelessly connect to the Internet 8 and upload the system information to the cloud computing system 12 and database 14 by communicating with one or more cell towers 7a, 7b, 7c via a LWAN radio technology standard; such as NB-IoT protocols or Cat-M1 protocols or regular cellular data service. Once the system information is loaded into the cloud based computing system 12 and database 14, a user may access the system information regarding the tool 100 from a web browser 24a using a general-purpose computer 24 (e.g., desktop computer, smartphone, workstation, and/or laptop computer, etc.). A user may also access the system information regarding the tool 100 from the App 20a installed on the mobile user device 20.

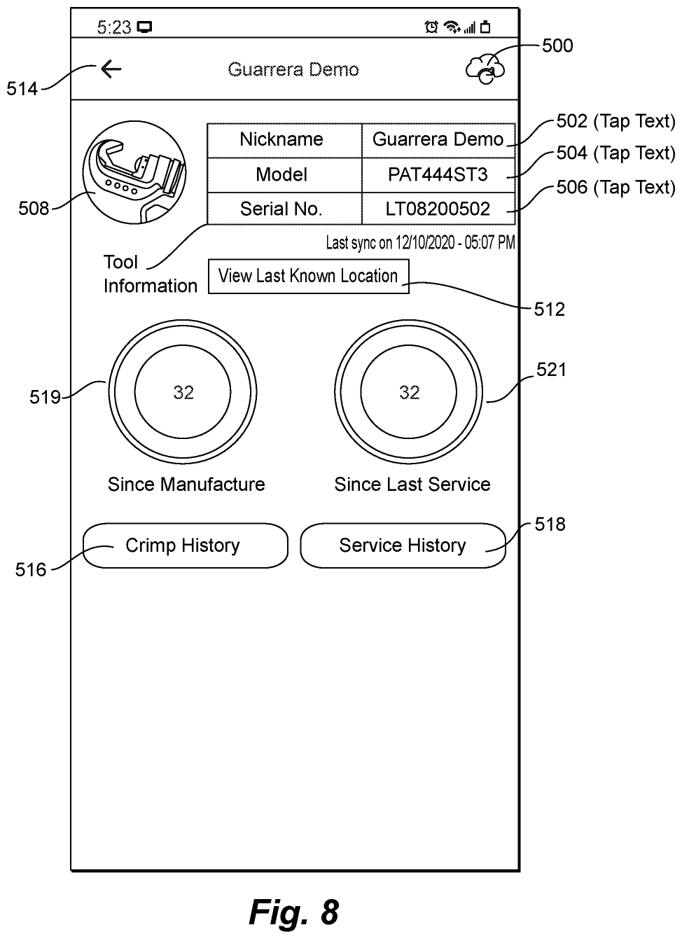

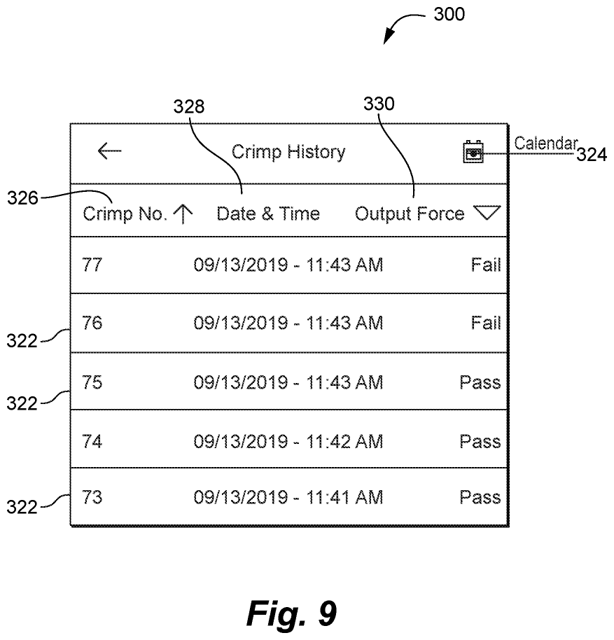

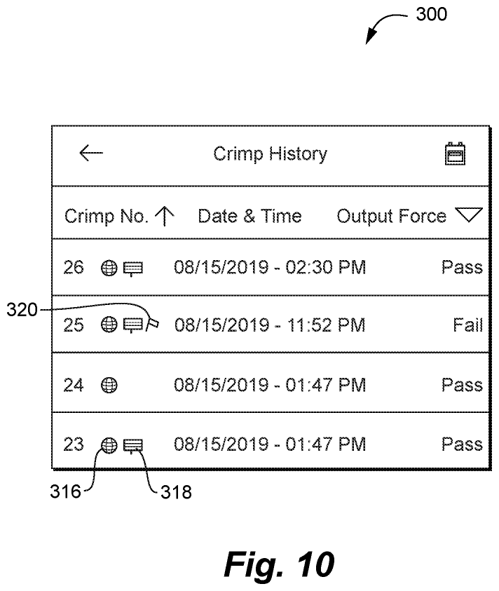

Referring now to FIGS. 8-13, the operation of an exemplary embodiment of a mobile app running on a smart phone as a mobile computing device 20 will be described. As shown in FIG. 8, after the App is connected to the tool 100, an exemplary tool information page 499 of the App is displayed on the smart phone display. Selecting (e.g., clicking on) the “Sync with Cloud” icon 500 initiates a sync operation between the App and the cloud computing system 12 and database 14 of the latest system information associated with the tool identified in the “Tool Information” fields. Tool information fields 498 include “Nickname-Guarrera Demo” 502, “Model-Pat444ST3” 504 and “Serial No.-ST08200502” 506. The Nickname field may include a unique identifier such as, for example, the name of a user or manager to which the tool 100 was last assigned, the name of the owner of the tool, a number of a truck to which the tool was last assigned, etc. Model field may include the model of the tool 100 and the Serial No. field may include the serial no. of the tool 100. An image 508 of at least a portion of the tool 100 may also be provided. Clicking arrow 514 will revert to a tool information modification page not shown but similar to FIG. 8, allowing a user to setup another tool in the system and/or allowing the user to modify the tool information fields for the tool displayed in FIG. 8. From the tool information modification page, the user can click on the Nickname, Model and Serial No. displayed in each field and modify it as desired. This allows the user, manager or tool user to assign an identifier to each unique tool 100 paired with the App and identified in the Tool Information fields. Icon 519 displays a number of crimps for the tool “Since Manufacture.” Icon 521 displays a number of crimps “Since Last Service.” Selecting the “Crimp History” icon 516 displays the Crimp History page 300 shown in FIG. 9. The Crimp History page 300 presents crimp information as a list of crimp data records 322 with an index column “Crimp No.,” 326, a time stamp column “Date & Time,” 328 and an “Output Force” column 330. According to this illustrative embodiment, the “Output Force” column 330 provides simple “Pass” or “Fail” status indicators indicating whether the maximum required force to achieve the crimp was achieved. In this exemplary page, the tool manager or the tool user can filter the records by date by selecting the “Calendar” icon 324 to list crimp data records 322 for a particular tool 100 identified in the Tool Information fields, seen in FIG. 8, to display only those crimp data records from the selected date or date range. The column headers, namely the “Crimp No.” and the “Output Force” headers, can be selected (e.g., tapped) to toggle between ascending or descending order of crimp numbers, or to filter crimps to those that have an Output Force of Pass or Fail. The Crimp History page 300 may or may not include additional icons to represent the crimp information associated with each crimp data record 322. For example, and referring to FIG. 10, an icon 316 may be used to represent whether the tool 100 successfully recorded in memory associated with processor 220 the location where the crimp was formed, an icon 318 can be used to represent whether or not there are comments saved for a particular crimp data record 322, or an icon 320 used to represent whether or not the crimp data record 322 includes a flag.

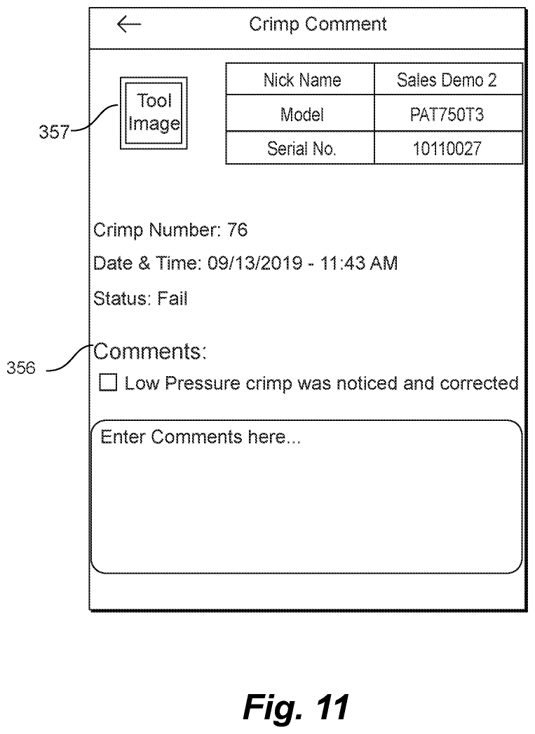

If an individual crimp data record 322, e.g., the Crimp No. 76 row of the crimp information displayed in FIG. 9, is selected by the tool manager or tool user, the crimp data record 322 for Crimp No. 76 would be presented on the display of the mobile computing device 20, as seen in FIG. 11. From this window, the tool manager or the tool user is able to review existing crimp comments 356 associated with the crimp data record or enter new comments about the selected crimp data record. Icon 357 may display a tool image or may be selected to show tool images. It is noted that these comments can also be reviewed, entered, and edited through the general-purpose computer 24 running on a web browser 24a connected to the tool management application running on the web services 22.

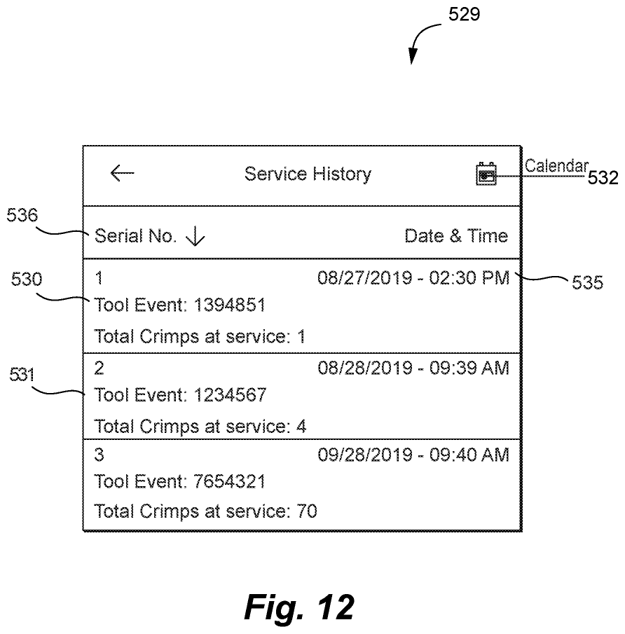

Referring again to FIG. 8, if the tool manager or the tool user selects the “Service History” icon 518, the page 529 shown in FIG. 12 is displayed. In this exemplary embodiment, the tool manager or the tool user can review, analyze and manage one or more tools 100 using the service history of the one or more tools 100 with service history records stored in the cloud computing system 12 and database 14. As described above, crimp information about one or more tools may be uploaded to the database 14. The crimp information and service history information for each tool 100 may then be used when displaying the Service History. As shown in FIG. 12, each service history data record may include, for example, a unique tool identification number as a “Tool Event 530,” the total number of crimps 531 performed by the specific tool having the serial number shown in space 536 since the time of last service as a “Total Crimps at Service,” and a time stamp as “Date & Time 535.” Through the Service History page 529, the tool manager or the tool user can filter service history data records by date by selecting the “Calendar” icon 532 in the top right of the page to display only those service history data records from the selected date. One or more column headers, which in this example the “Service No.” headers, can be selected (e.g., tapped) to toggle between ascending or descending service numbers.

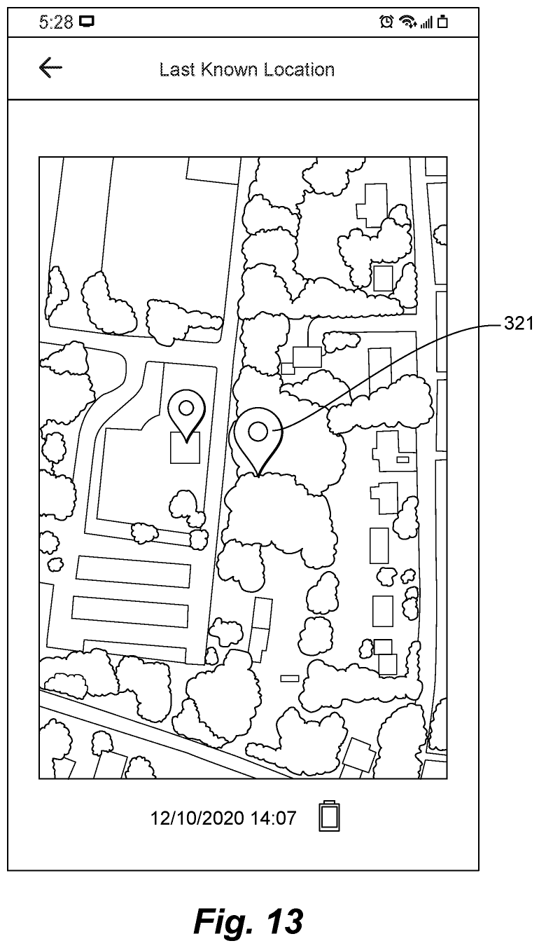

Continuing to refer to FIG. 8, if the tool manager or the tool user selects the “View Last Known Location” icon 512, the page shown in FIG. 13 is displayed. In this exemplary embodiment, the tool manager or the tool user can view the last transmitted location of the tool. In the exemplary embodiment of FIG. 13, the location of the tool is overlaid on the map. Icons 324 can be used to display the location of the tool on the map. The icons 324 may have a typographic designation or color coding, e.g., Green, Yellow, or Red, to show the level of charge of the battery 170 of the tool 100. The map may include landmark information, such as the location and name of towns, streets, power lines, transmission towers, buildings and the like to provide the tool manager or the tool user with information to show the tool's location or last known location. According to an embodiment of the present disclosure, clicking on icon 324 may display a window (not shown) with an actual address at or closest to the tool's location or last known location. As described above, this information may also include altitude information that may be used to ascertain the floor on which the tool is located at that address or location.

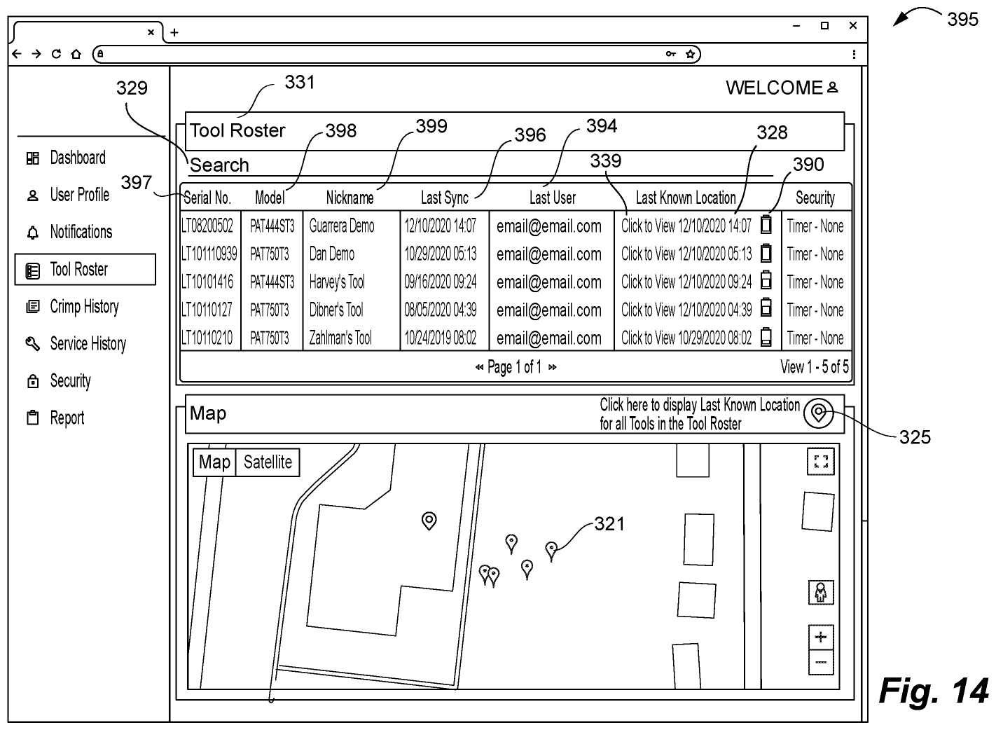

Referring to FIGS. 14-16, an exemplary page display of an external device, such as a general-purpose computer 24 connected to the database 14 via a web browser is shown. Although the information described with respect to FIGS. 14-16 may also be displayed on a mobile device such as a smartphone, it is preferably displayed in a more readable, user-friendly format, on a full-sized screen. In this example, crimp information and other tool data for one or more tools 100 has been transferred into the database 14. After general-purpose computer 24 is logged onto the present website via a web browser, an exemplary tool information page 395 of the website is displayed on the computer display as shown in FIG. 14. The tool information and other tool data from the database 14 may be displayed in a window titled “Tool Roster 331” or “Roster” of a web page loaded onto the computer 24. This tool information and other tool data in the Tool Roster 331 may be presented as a table showing an alpha-numeric identifier for each tool 100, e.g., “Serial No. 397,” another alpha-numeric identifier showing the model number 398 for each tool 100, e.g., “Model,” a tool “Nickname 399” identifier which the tool manager or user may assign for each tool 100, a time stamp for each last sync 396 of tool information, e.g., a date and time 328 for each last sync 396 of tool information, an email and/or name of a last tool user 394, e.g., “Tool User,” a time stamp for the last known location which may also include an icon 390 showing the tool's battery charge, e.g., “Last Known Location 339.”

Continuing to refer to FIG. 14, a user can search the Tool Roster for a specific tool using the search box 329 by typing in the desired tool's serial number or nickname to quickly find the tool 100. It is also contemplated that a search may be made using the Last User information to generate a list of tools that were last used by a specific tool user.

According to an embodiment, the tool information retrieved from database 14 based on the selected or entered filter criteria may also be displayed graphically on a map, as seen in FIG. 14. In the exemplary embodiment of FIG. 14, the location of each tool 100 is overlaid on the map shown in FIG. 13. Icons 321 can be used to display the location of the tools on the map. The icons 321 may have a typographical designation or color coding, e.g., Green, Yellow or Red, to indicate the level of charge of the battery 170 of the tool. The map may include landmark information, such as the location and names of towns, streets, power lines, transmission towers, buildings and the like to provide the tool manager or the tool user with information to show the location of the tools. The Last Known Location column may include a link, e.g., “Click to View,” 339 that allows a user to single out the desired tool's location on the map. A tool user may also click on icon 512 as shown in FIG. 8 to show the location of the tools on the Tool Roster or the tools that were identified from a search result as previously described.

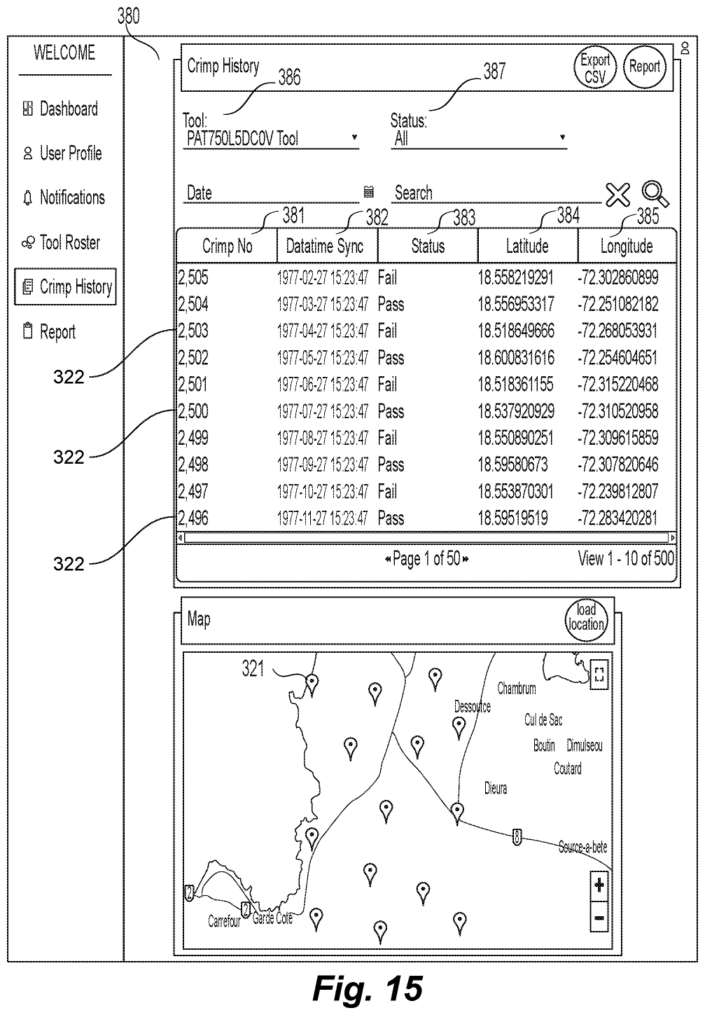

Referring now to FIG. 15, the system information including the crimp information and other tool data from the database 14 may be displayed in a window titled “Crimp History” 380 of a web page loaded into the general-purpose computer 24. This crimp information and other tool data in the Crimp History may be presented as a table showing an index number for each crimp, e.g., “Crimp No” 381, a time stamp for each crimp 382, e.g., a date and time for each crimp, a crimp “Status” identifier 383 showing whether sufficient pressure or force was applied to form the crimp. The crimp Status may be logical value that may be presented as a “Pass” or “Fail” or the crimp Status may be represented as the pressure or force applied to form the crimp, and the location where the crimp was formed, in for example, the latitude 384 and longitude 385 of the tool 100 when the crimp was formed.

A user can filter the crimp information displayed by the general-purpose computer 24 by entering filter criteria. Non-limiting examples of filter criteria include the identity of a particular tool in a “Tool” field 386, tools with a particular status in a “Status” field 387, a date crimps were made in a “Date” field, and a user defined alpha-numeric search in a “Search” field. To illustrate, if a user selects or enters a particular tool 100 in the “Tool” field 386, such as the “PAT750L5DC0V” tool, as seen in FIG. 15, each of the crimp data records 322 of crimp information formed by that tool would be displayed in the Crimp History window 380. In this exemplary embodiment, the crimp information displayed for each crimp data record 322 includes a time stamp e.g., Datatime Sync 382, whether the crimp was formed with sufficient force, indicated by a logical Pass or Fail status value 383, and the location (in latitude 384 and longitude 385 format) where the crimp was formed. According to one embodiment, the designation whether the Status field of a crimp data record has a Pass or Fail status may be indicated by the color of the typeface (or font) used to display the crimp data record 322. For example, a green font may be used if the status is Pass and a red font may be used if the Status is Fail. A wide variety of filter criteria can be applied to filter the crimp information stored in the database 14 for presentation to the tool manager or the tool user. For example, a tool manager or tool user could query the database 14 to show only crimp data records 322 which have a Status of “Fail,” or to show crimp data records formed within a date or time range, or to show crimp data records 322 formed within a certain geographic range, and the like. Other display windows (not shown) could be provided to allow a user to enter Boolean logic operators (AND, OR, NOT, etc.) to combine filters using techniques known to those skilled in the relevant field could also be applied.

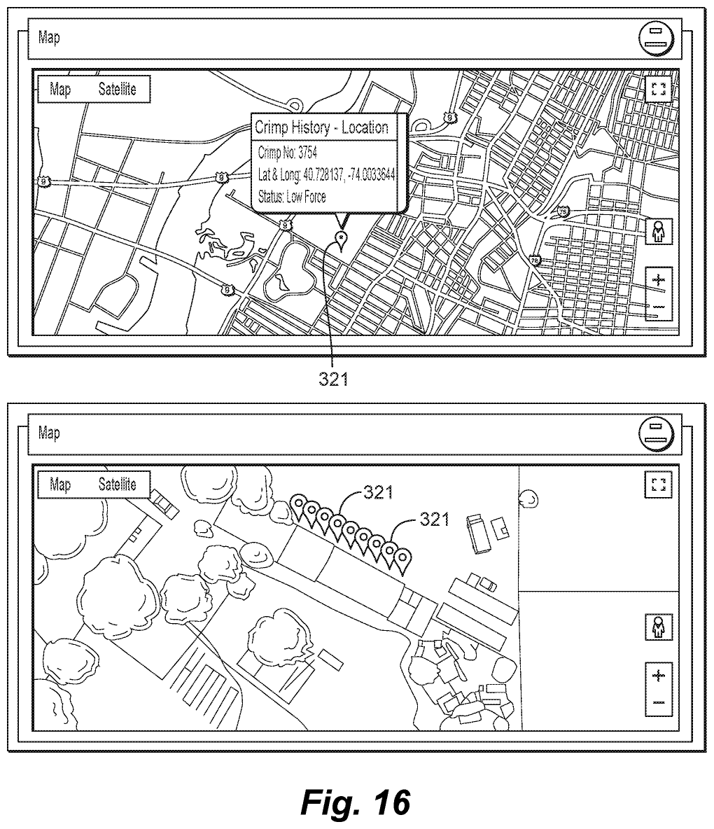

According to one embodiment, the crimp information retrieved from the database 14 based on the selected or entered filter criteria can also be displayed graphically on a map, as seen in FIGS. 15 and 16. In the exemplary embodiment of FIGS. 15 and 16, the location of each of the crimps for tool PAT750L5DC0V (that fit the filter criteria) are overlaid on the map. Icons 321 can be used to display the location of the crimps on the map. The icons 321 may have a typographic designation or color coding, e.g., Green or Red, to show that the particular crimp has a “Pass” or “Fail” status. The map may include landmark information, such as the location and names of towns, streets, power lines, transmission towers, buildings and the like to provide the tool manager or the tool user with information to show the location where crimps or other tool operations were performed. According to one embodiment, the crimp information from multiple crimps and/or other tool operations can be used to track progress on a job site, grounding grids, or other work sites. According to another embodiment, instead of providing a map showing the locations of crimps, the web services 22 can analyze the crimp information to determine the street address of the job site where the crimps were formed. The street address of the crimp could be provided as text.

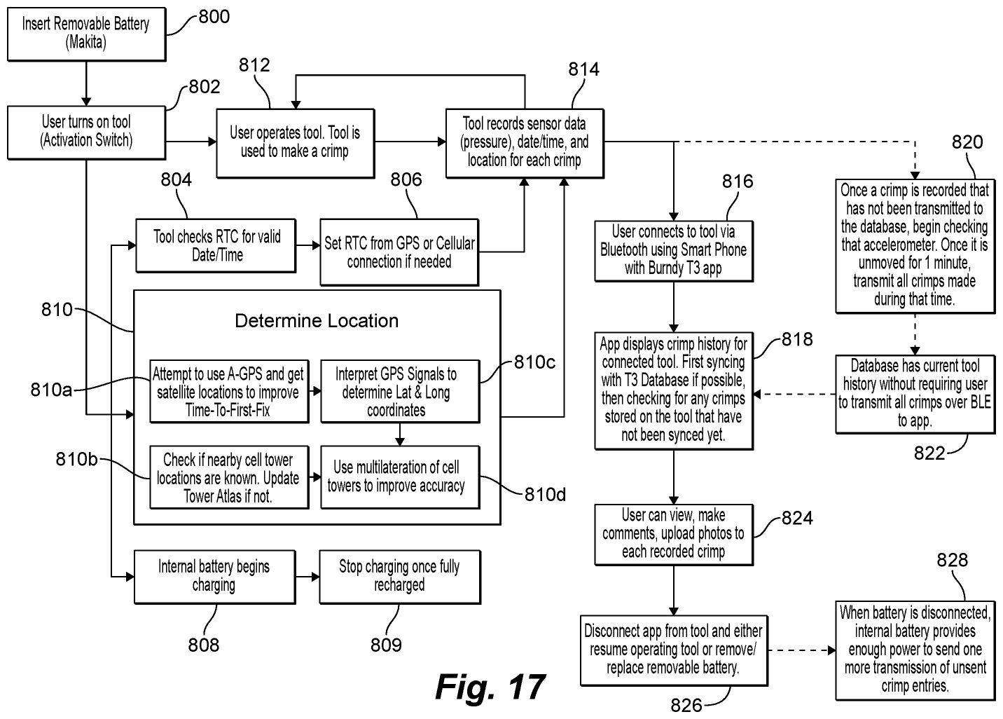

FIG. 17 shows a process diagram according to an illustrative embodiment of the present disclosure, for describing the use of a tool 100 associated with a tool system 10. This description will continue the practice of describing the tool system 10 associated with a tool 100 that is a portable, handheld, battery powered, hydraulic crimping tool used to form crimps and other electrical connections on workpieces. At step 800 and 802, power is supplied to the tool 100, for example, by inserting battery 170 and the user activating a switch or button (not shown). It is envisioned that inserting the battery 170 may automatically provide power to the tool 100. Upon receiving power, the tool 100 checks real-time clock (RTC) 217 (FIG. 5) for valid date/time at step 804 and sets RTC 217 using the GPS system associated with the location module 210 and/or the cellular modem 214 if needed at step 806. With battery 170 inserted into the tool 100, at step 808 the battery 170 begins charging the internal battery 232 if the internal battery's charge is below the acceptable threshold and stops charging the internal battery 232 once the internal battery 232 has been fully recharged (Step 809). As previously described, the internal battery 232 powers the communication controller 200. Once the charge of the internal battery 232 falls below the required level of charge that allows the communication controller 200 to transmit system information that has not yet been uploaded, the recharging circuit 218 uses power from the battery 170 to recharge the internal battery 232. At step 810, the tool 100 determines the location of the tool 100 utilizing steps 810a, 810b, 810c, and 810d. At step 810a, the tool 100 attempts to use A-GPS and get satellite locations to improve TTFF. At step 810b, the tool 100 checks to see if nearby cell tower locations are known from the Tower Atlas. If nearby cell tower locations are not known, the Tower Atlas may be updated. At step 810c, the GPS signals received by the location module 210 are interpreted to determine the latitude and longitude coordinates of tool 100. At step 810d, the cellular modem 214 may utilize multilateration of cell towers to improve accuracy of the determined location. According to an embodiment of the present disclosure, Step 810 may be initiated with every action on the workpiece so that the location of each crimp may be recorded. For example, once a crimp has been made on a workpiece, at step 814 tool 100 records system information data collected relating to the crimp, such as, pressure determined by a pressure sensor 188 i.e., force sensor (FIG. 4), date/time determined by the RTC 217, and/or location of the tool 100 determined by the location module 210 (FIG. 5) and/or cellular modem 214. Step 810 is may also be initiated when a triggering event occurs as described in more detail below.

After crimps are completed (e.g., after a predetermined amount of time has passed since the last crimp), the system information recorded from the crimp cycle may be uploaded to the database 14 by a user and/or may be automatically uploaded to the database 14. For example, according to an illustrative embodiment of the present disclosure, for the system information to be uploaded manually by a user, at step 816 the user pairs the tool 100 using WLAN technology, e.g., BLE, with a mobile device 20, e.g., smart phone, having an app associated with the tool system 10. At step 818, the app displays the work cycle history, e.g., crimp history, as seen in FIG. 6, for the connected tool 100. The mobile device 20 first syncs with the database 14, then checks for any crimps stored in the tool 100 that have not yet been synced to the database 14. Any crimps that are found to not be in the database 14 gets uploaded to the database 14. According to another illustrative embodiment of the present disclosure, for the system information to be uploaded automatically, at step 820, once a crimp is recorded that has not been transmitted to the database 14, the processor begins checking the IMU sensor 216 (FIG. 5), e.g., accelerometer. When the IMU sensor 216 detects no movement of the tool 100 for a predetermined amount of time, e.g., 1 minute, the communication controller 200 will automatically transmit all crimps made during that time period to the database 14. The database 14 will then have the current system information of the tool 100 without requiring the system information to be transmitted to the mobile device 20 having the app at step 822. At step 824, a user may be able to view, make comments, upload photos to reach recorded crimp via a mobile device 20 with the app and/or a general-purpose computer (e.g., desktop, workstation, and/or laptop computer) via a browser. At step 826, after the system information has been successfully uploaded, a user may disconnect the tool 100 from the app and either resume operating the tool 100 or remove and/or replace the battery 170. At step 828, when the battery 170 is on longer providing power to the tool 100 (e.g., the battery 170 is disconnected or runs out of a sufficient charge to operate the tool 100), the internal battery 232 provides enough power to send one more transmission of unsent system information.

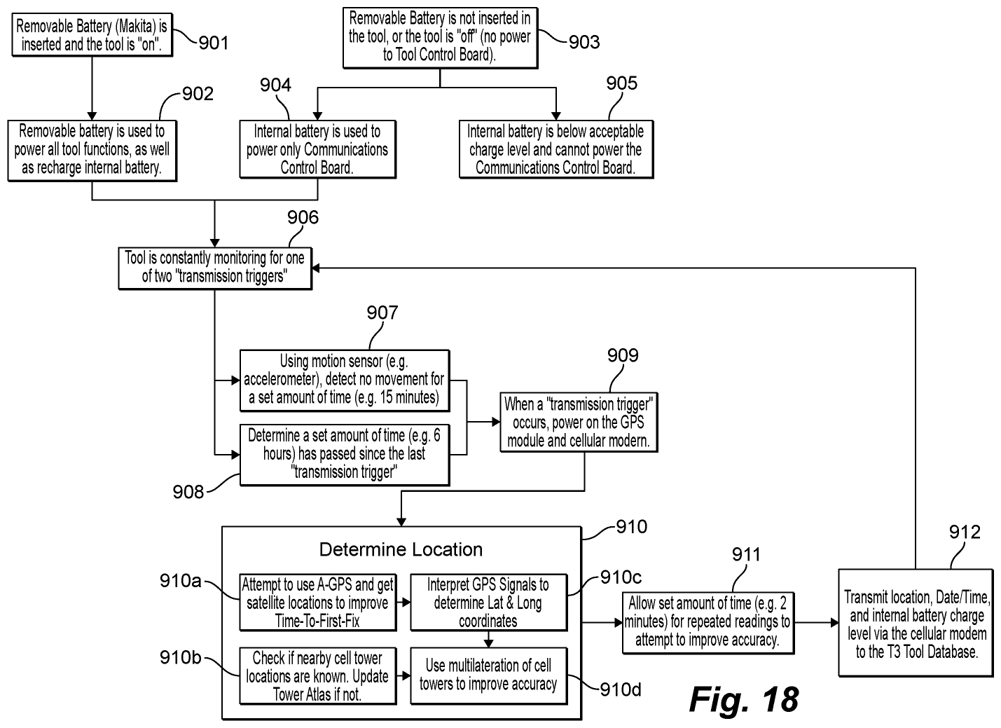

FIG. 18 shows a process diagram of ongoing state of the tool system 10. At step 901 and 902, the battery 170 is inserted into the tool 100 and powers all electric and electromechanical devices associated with the tool 100 and recharges the internal battery 232. In step 903, the battery 170 is not inserted into the tool 100 and/or power is “off” to the tool 100. The internal battery 232 is then used to provide power to the communication controller 200 (see step 904) so that the communication controller 200 may transmit system information which may include information identifying the location of the tool 100 to the database 14. If the internal battery 232 is below a level of charge capable of powering the communication controller 200, the communication controller 200 will be unable to transmit system information and/or the location of the tool 100 (see step 905). In step 906, the tool system 10 is constantly monitoring for a triggering event. A triggering event may be when the IMU sensor 216 detects no movement for a predetermined amount of time, e.g., 15 minutes, and/or after a predetermined amount of time has passed since the last triggering event occurred (see step 907 and 908). In step 909, when a “trigger” occurs, power is supplied to the location module 210 and the cellular modem 214. In step 910, the location module 210 and the cellular modem 214 determine the location of the tool 100 . . . . At step 910 the tool 100 determines the location of the tool 100 utilizing steps 910a, 910b, 910c, and 910d. At step 910a, the tool 100 attempts to use A-GPS and get satellite locations to improve TTFF. At step 910b, the tool 100 checks to see if nearby cell tower locations are known from the Tower Atlas. If nearby cell tower locations are not known, the Tower Atlas may be updated. At step 910c, the GPS signals received by the location module 210 are interpreted to determine the latitude and longitude coordinates of tool 100. At step 910d, the cellular modem 214 may utilize multilateration of cell towers to improve accuracy of the determined location. According to an embodiment of the present disclosure, Step 910 may be initiated with every action on the workpiece so that the location of each crimp may be recorded. For example, once a crimp has been made on a workpiece, tool 100 records system information data collected relating to the crimp, such as, pressure determined by a pressure sensor 188. In step 911, after the location has been determined by step 910, a set amount of time, e.g., 2 minutes, is allowed to pass and the sequence for determining the tool's 100 location is repeated in an attempt to improve the accuracy of the determined location from step 910. In step 912, the cellular modem 214 transmits the location, date/time, and internal battery charge level of the tool 100 to the database 14. The cycle then continues with the tool 100 going back to step 906 and monitoring for a triggering event.

According to an embodiment of the present disclosure, a triggering event may be when the IMU sensor 216 (FIG. 5) i.e. an accelerometer detects no movement for a predetermined amount of time, e.g., 15 minutes, and/or after a predetermined amount of time has passed since the last triggering event occurred. One of ordinary skill in the art will appreciate that other triggering events may be used depending on, for example the user's preferences, type of tool, etc. Upon the occurrence of a triggering event, the location module 210 and the cellular modem 214 turn on to determine the location of the tool 100. The cellular modem 214 attempts to use A-GPS to acquire satellite locations in order to improve Time-To-First-Fix (TTFF). The location module 210 then interprets satellite signals from GPS technologies as discussed above to determine the latitude and longitude coordinates. While the cellular modem 214 is acquiring satellite locations via A-GPS, the cellular modem 214 may also be checking the Tower Atlas to determine if nearby cell tower locations are known. Multilateration of cell towers may then be used to improve accuracy of the determined location. After a set amount of time, e.g., 2 minutes, the sequence for determining the tool's location is repeated in an attempt to improve the accuracy of the determined location. The cellular modem 214 may then transmit the location, date/time, and a value representing the remaining charge on the internal battery to the cloud computing system 12 and database 14.

According to another exemplary embodiment, the IMU sensor 216, e.g., an accelerometer, may be used to determine whether the tool 100 is moving, i.e., being moved, or stationary. If stationary, the components, e.g., transceivers and processors, are allowed to sleep or power down, or extend wake intervals, to conserve power, and the communication controller 200 can periodically emit a transmission to its paired mobile computing devices 20 using the Bluetooth Low Energy (BLE) transceiver or other known technique and/or emit a transmission to its database 14 using LPWAN.

As described herein, the tool 100 according to the present disclosure is capable of communicating with multiple mobile computing devices 20 via, for example, Bluetooth or Wi-Fi technology to receive system information from the tool 100, such as GPS location of the tool and/or crimp history associated with the tool 100. It is noted that the tool 100 of the present disclosure contemplates using other RF technologies for communication, including sub-gigahertz technologies and radios. The communication controller 200 may also be configured to connect to a mobile computing device 20 and upload system information to the mobile computing device 20 via a mobile app over Bluetooth.

As shown throughout the drawings, like reference numerals designate like or corresponding parts. While exemplary embodiments of the present disclosure have been described and illustrated above, it should be understood that these are exemplary of the disclosure and are not to be considered limiting. Additions, deletions, substitutions, and other modifications can be made without departing from the spirit of the present disclosure. Accordingly, the present disclosure is not to be considered as limiting by the foregoing description.

What is claimed is:

1. A tool tracking system comprising:
a location module, configured to receive location information used to determine a tool's location;
a communication controller configured to communicate with at least one of a mobile computing device and a cloud-based computing system; and
wherein upon a triggering event, the communication controller transmits at least one of the received location information and the tool's location to the at least one mobile computing device and the cloud-based computing system.

2. The tool tracking system according to claim 1, wherein the communication controller further comprises a user input configured upon activation to transmit system information from a tool to a cloud-based computing system.

3. The tool tracking system according to claim 1, wherein the communication controller further comprises a motion sensor configured to detect whether a tool is stationary or non-stationary.

4. The tool tracking system according to claim 3, wherein the motion sensor is an accelerometer.

5. The tool tracking system according to claim 1, wherein the communication controller further comprises a rechargeable battery configured to provide power to the communication controller in the absence of another power source.

6. The tool tracking system according to claim 1, wherein the short-range communication module is configured to employ a Bluetooth Low Energy communications protocol.

7. The tool tracking system according to claim 1, wherein the short-range communication module is configured to employ an IEEE 802.11 wireless local area network protocol.

8. The tool tracking system according to claim 1, wherein the cellular modem utilizes a low power wide area network radio technology standard.

9. The tool tracking system according to claim 8, wherein the low powered wide-area network is operable according to Cat-M or NB-IoT protocols.

10. The tool tracking system according to claim 1, wherein the communication controller is configured to be removably mounted to a tool.

11. A communication controller removably connectable with a tool, the communication controller comprising:
a cellular modem;
a location module, wherein the location module is configured to determine location associated with the tool;
a short-range communication module, wherein the communication module is configured to communicate with a user's mobile device; and
a processing element connected with the cellular modem, the location module, and short-range communication module, wherein the processing element receives system information and upon a triggering event transmits the system information to a cloud-based computing system.

12. The communication controller according to claim 11 further comprising a user input configured upon activation to transmit system information from a tool to the cloud-based computing system.

13. The communication controller according to claim 11 further comprising a motion sensor configured to detect whether a tool is stationary or non-stationary.

14. The communication controller according to claim 13, wherein the motion sensor is an accelerometer.

15. The communication controller according to claim 11, wherein the triggering event is a predetermined amount of time from the last transmission.

16. The communication controller according to claim 13, wherein the triggering event is the detection of the tool remaining stationary for a predetermined amount of time.

17. The communication controller according to claim 11 further comprising a rechargeable battery configured to provide power to the communication controller in the absence of another power source.

18. The communication controller according to claim 17, further comprising a circuit configured to recharge the rechargeable battery.

19. The communication controller according to claim 11, wherein the short-range communication module is configured to employ a Bluetooth Low Energy communications protocol.

20. The communication controller according to claim 19, wherein the short-range communication module is configured to employ an IEEE 802.11 wireless local area network protocol.

21. The communication controller according to claim 11, wherein the cellular modem utilizes a low power wide area network radio technology standard.

22. The communication controller according to claim 21, wherein the low powered wide-area network is operable according to Cat-M or NB-IoT protocols.

23. A communication controller comprising:
a cellular modem, wherein the cellular modem includes an internal processor configured to receive system information and upon a triggering event transmits the system information to a cloud-based computing system;
a location module, wherein the location module is configured to determine location associated with a tool; and
a short-range communication module, wherein the short-range communication module is configured to communicate with a user's mobile device.

24. The communication controller according to claim 23 further comprising a user input configured upon activation to transmit system information from a tool to the cloud-based computing system.

25. The communication controller according to claim 23 further comprising a motion sensor configured to detect whether a tool is stationary or non-stationary.

26. The communication controller according to claim 25, wherein the motion sensor is an accelerometer.

27. The communication controller according to claim 23, wherein the triggering event is a predetermined amount of time from the last transmission.

28. The communication controller according to claim 23, wherein the triggering event is the detection of the tool remaining stationary for a predetermined amount of time.

29. The communication controller according to claim 23 further comprising a rechargeable battery configured to provide power to the communication controller in the absence of another power source.

30. The communication controller according to claim 29, further comprising a circuit configured to recharge the rechargeable battery.

31. The communication controller according to claim 23, wherein the short-range communication module is configured to employ a Bluetooth Low Energy communications protocol.

32. The communication controller according to claim 23, wherein the short-range communication module is configured to employ an IEEE 802.11 wireless local area network protocol.

33. The communication controller according to claim 23, wherein the cellular modem utilizes a low power wide area network radio technology standard.

34. The communication controller according to claim 33, wherein the low powered wide-area network is operable according to Cat-M or NB-IoT protocols.
